(19) United States
(12) Patent Application Publication
(10) Pub. No.: US 2013/0180158 A1
(43) Pub. Date: Jul. 18, 2013

(54) FISHING LURE

(71) Applicant: Leslie C. Butters, Flagstaff, AZ (US)

(72) Inventor: Leslie C. Butters, Flagstaff, AZ (US)

(21) Appl. No.: 13/742,932

(22) Filed: Jan. 16, 2013

Related U.S. Application Data
(60) Provisional application No. 61/632,119, filed on Jan. 17, 2012.

(51) Int. Cl. A01K 85/02

(52) U.S. Cl. CPC A01K 85/02
USPC 43/42.1; 43/42.53

(57) ABSTRACT

A fishing lure including a hook and a strip of self-adhering flexible material wherein the strip is wrapped around a portion of a bait and the strip reinforces the attachment of the hook to the bait. The strip may be a self-adhering elastomeric strip. The strip may be easily and effectively applied by hand.

### CROSS REFERENCE TO RELATED APPLICATIONS

This patent application claims priority to and the benefit of Provisional Patent Application Ser. No. 61/632,119 entitled Improved Fishing Lure, filed Jan. 17, 2012, incorporated by reference herein in its entirety.

### FIELD OF THE INVENTION

The present invention relates to the field of fishing lures used at the end of fishing lines, and to methods of securing and retaining fishing baits to fish hooks.

### BACKGROUND OF THE INVENTION

A fishing lure is an artificial bait equipped with one or more hooks that is often designed to resemble fish prey or an object that triggers a predatory fish's instincts to attack, strike and engulf the prey. Artificial baits are typically designed to imitate the “feel” and “taste” (impregnation of salts, oils and other attractants) of the fishes' prey to encourage a fish to attack, strike, engulf and retain the bait long enough for the angler to set the hook and imbed hook into the fish's mouth. The bait may also include a jig consisting of a weighted sinker with one or more hooks molded into it. The bait may be positioned on the jig with the point of the hook exposed externally of the bait or not exposed (contained within the bait). Baits may vary in material, weight, size, durometer, dimension, location and orientation along the hook. Hooks may also vary in style, type, color, configuration, gap from hook shank to point, shank length, angle and material.

Fishing hooks are conventionally inserted through baits either transversely so that the curved portion of the hook passes transversely through the bait, or alternatively the hook is inserted into the bait so that the shank of the hook extends axially through the proximal end of the bait (the end closer to the angler). In this latter configuration the curved portion of the hook typically passes transversely across the bait with the tip of the barbed hook either extending through the top side of the bait (usually in the vicinity of the middle region of the bait) or contained within the bait (also usually nearer to the middle region of the bait). The hook/s may be located along any length of the bait. The bait is virtually always mechanically weakened by the process of inserting the hook. The inserting of the hook through the bait, whether artificial or natural bait, may create undesirable tears in the body of the bait.

Casting and retrieving a fishing lure can exert considerable stress on the bait. The application of this stress is repeated through every cast and retrieval, which can obviously happen many times. During the act of retrieving the fishing lure a predatory fish may attack or strike without the hook penetrating and securing the fish to the hook and fishing line. In many cases the predatory fish bites a bait, pulling and relocating it a distance down the hook shank or weighted sinker molded shank without the hook imbedding into the fish's mouth. Likewise, the fishing lure may contact and get snagged or stuck on a myriad of above water or underwater objects such as trees or rocks during the act of casting and retrieving. Attempts to release the fishing lure from such objects may include violently jerking and pulling the fishing line. In many cases the fishing lure releases from the object with the artificial bait repositioned down the length of the jig or hook. During the remainder of the retrieve the repositioned artificial bait loses its life-like presentation resulting in the predatory fish rejecting and refusal to attack, strike or engulf the bait. Alternatively, the bait is often simply lost (or severely damaged) during retrieval which may involve abrupt, violent release of a snagging object.

Multiple relocations of the bait from along the weighted sinker shank or along the hook create increased damage to the internal bait body resulting in a loose fit to the jig or to the hook. In relatively a short period of time the damaged bait progressively loses its ability to remain on the jig and hook/s for a life-like presentation.

Additionally, baits are constantly removed and replaced with the same or different styles, configurations and colors to enable the angler the best opportunity to attract fish to attack, strike and engulf. It is considered important to be able to quickly and easily switch to another bait type, color or configuration.

### SUMMARY OF THE INVENTION

A fishing lure is described that includes a hook, a bait and at least one strip of self-adhering flexible material wherein the strip is wrapped so as to form at least one circumferential, radially wrapped band around a portion of the bait and around a portion of the hook. The hook is inserted into the bait prior to wrapping with the strip. Alternatively, the hook may be inserted through the strip after the bait has been wrapped with the strip, or in another alternative a portion of the hook extends through or under the loop formed by the wrapped strip. The strip is typically circumferentially wrapped with moderate tension applied to the self-adhering material creating radial compression around a portion of the outer surface of a bait such as a soft, artificial bait of a material such as plastisol. The wrapping is accomplished in a manner to retain the preferred location between the hook and bait and reinforces that portion of the bait that includes a portion of a fishing hook. This effective reinforcement resists loss and severe damage of the bait during retrieval and helps prevent relative displacement of the bait with respect to the hook that causes the bait to behave in an undesired, unnatural fashion with loss of its life-like prey presentation.

The strip is relatively long in comparison to its width, the length typically being at least several times the width. The strip is relatively thin and has two opposing ends. The strip may comprise a fabric or a polymer which in one embodiment is an elastomeric polymer.

“Flexible” describes that the strip has flexibility appropriate to allow it to be easily wrapped by hand around the outer surface of a bait. It is also apparent that the strip of self-adhering flexible material will have tensile strength adequate to allow it to function as described herein.

The self adhering strip of flexible reinforcing material is quickly and easily applied, is inexpensive and is effective in retaining location of a bait to a hook.

Localized reinforcement using self-adhering material resists hook displacement and bait damage without reduction of life-like presentation of the bait.

Multiple locations of the wrap for areas of bait reinforcement and resistance to hook displacement may be desired.

In one embodiment the strip of flexible reinforcing material is a strip of self-adhering elastomeric material such as silicone.

The strip of material may include an additional adhesive in another embodiment to allow the inner surface of outer end of the wrapped strip to adhere to the underlying wrap of the strip.

In another embodiment the strip may include Velcro™ to allow it to adhere to itself.

Any embodiments of the self-adhering flexible strip may be provided with

impregnation or coating of salts, oils and other attractants known in the art to aid in luring fish. The strip may also be provided in various colors including red, which is believed by some anglers to attract fish. Colorant may be added to provide the strip in any color or colors desired. For purposes of this document, “color” includes white, black, transparent and translucent.

While the strip is easily, simply and effectively wrapped around a hook and bait by an angler's hand, it may also be wrapped as part of a manufacturing process, where wrapping could be accomplished by machine.

### BRIEF DESCRIPTION OF THE DRAWINGS

FIGS. 1A-1B describe different types of conventional fishing hooks, and parts thereof, of the prior art.

FIGS. 1C-E show fishing hooks inserted into artificial baits as known in the prior art.

FIG. 1F shows a fishing lure of the prior art with a bait having a portion of the shank of a hook inserted axially through the proximal end of a bait and having the curved portion of the hook inserted transversely through the middle region of the bait.

FIGS. 1G-I show lures of the prior art having fishing hooks secured to baits with O-rings.

FIG. 2 shows a strip of self-adhering strip of material as described herein for reinforcing a portion of a bait that is joined to a fishing hook.

FIG. 3A shows the application of a strip of self-adhering strip of material to a portion of a bait having the shank of a fishing hook inserted axially therethrough.

FIG. 3B shows a portion of a bait having the shank of a fishing hook inserted axially therethrough, after the application of a strip of self-adhering material to the portion of the bait.

FIG. 3C shows a transverse cross section of FIG. 3B taken at the location of the applied strip of self-adhering material.

FIG. 3D shows a portion of a bait having the molded, weighted sinker shank of the fishing hook inserted axially therethrough, after the application of a strip of self-adhering material to the portion of the bait located at the belly of the weighted sinker shank, and after that optional application of a second strip of self-adhering material to the middle region where the hook exists transversely through the bait.

FIGS. 4A and B show fishing hooks secured to portions of baits that have been reinforced with a strips of self-adhering material.

### DETAILED DESCRIPTION OF THE DRAWINGS

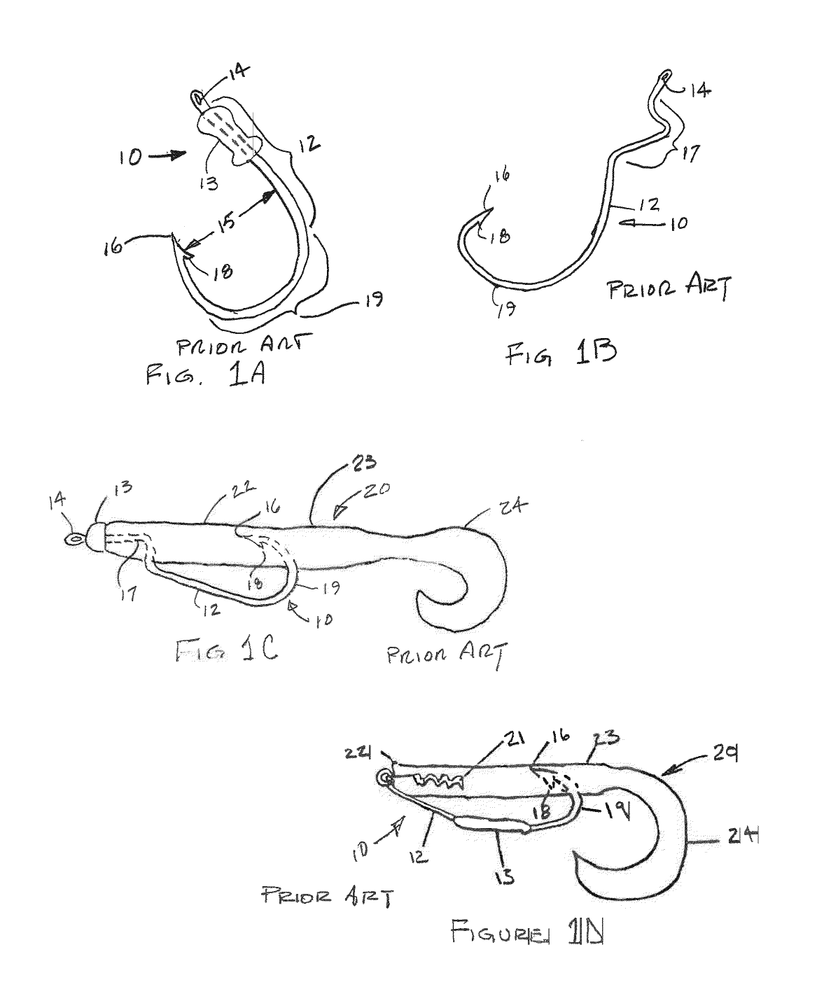

FIGS. 1A-1B describe different types of conventional fishing hooks, and parts thereof, of the prior art. FIG. 1A is a perspective view of a fishing hook 10 of a very basic design, having a shank 12 followed by a bend 19 and ending in a point 16 having an adjacent barb 18. A gap 15 exists across the space between the shank 12 and point 16. For purposes of this description, hook 10 has a proximal region including the eye 14 at the proximal end for attaching a fishing line and also including the shank 12. The distal region includes the bend 19, point 16 and barb 18. Hook 10 may also be provided with an optional weight or sinker 13, which may be affixed to various parts of the hook.

FIG. 1B is a perspective view of a slightly different fishing hook of the prior art including a belly section 17 in the proximal region of the hook 10.

FIGS. 1C-E show fishing hooks inserted into artificial baits as known in the prior art. These artificial baits are made to resemble various creatures such as worms, grubs, shad, crayfish, crabs, shrimp etc. They are often made from soft, flexible materials such as highly plasticized plastics such as plastisols. Plastisols are generally described as suspensions of polyvinyl chloride particles in a plasticizer. They may be heated, for example to about 177 degrees C. for pouring into a mold to create the desired shape of the bait. On cooling the mold to below, for example, about 60 degrees C., the soft, flexible, permanently plasticized bait results. The use of these soft, flexible materials allows for life-like feel and movement of the bait, including bending movements as the bait is pulled through water. These baits are soft and flexible to the extent that they may be easily bent or compressed to a thinner dimension with the fingers and thumbs. Other soft and flexible materials may also be such as low durometer silicones; however, plastisols are most typical.

FIG. 1C is a perspective view of an artificial bait 20 having a hook 10 inserted into portions of the bait. In this instance, the belly portion 17 of hook 10 has been inserted axially through the proximal region 22 of the bait 20 while the point 16, barb 18 and part of bend 19 have been inserted transversely through middle region 23 of bait 20 with point 16 and barb 18 remaining within the middle region 23 of bait 20. Bait 20 also includes a distal region 24, sometimes in the form of a tail.

FIG. 1D shows a fishing lure of the prior art having a retention coil 21 to aid in securing the hook 10 to an artificial bait 20. The retention coil 21 is inserted axially into the proximal region 22 of the artificial bait 20. It is quite difficult to insert the retention coil 21 into bait 20 while orienting hook 10 into the midsection 23 of the artificial bait with point 16 and barb 18 remaining within the middle region 23 of bait 20 in a manner that provides a life-like prey presentation of the bait.

FIG. 1E shows a lure of the prior art having a fish hook 10 with a molded weight 13 having a smaller diameter belly portion 17 between two larger diameter weights 13, with the belly portion 17 and larger diameter distal weight 13 inserted axially into the proximal region 23 of artificial bait 20.

FIG. 1F is a perspective view of prior art lure showing a bait 20 having a hook 10 inserted transversely through a middle region 23 of bait 20.

FIGS. 1G and 1H show perspective views of prior art lures including an O-ring 26 fitted to the middle region 23 of a bait 20. FIG. 1G shows how a hook 10 may be secured to the side of the middle portion 23 of bait 20, while FIG. 1H shows a hook 10 positioned passing transversely through the cross-sectional diameter of the middle region 23 of bait 20 so that it passes through the center of O-ring 26. It is well appreciated that O-rings are endless, meaning that the ring is integral and without ends.

For purposes of reinforcement to enhance securement of hook 10 to bait 20, O-rings are difficult to fit and size over the soft, pliable and compressible bait. The choice of O-ring inside diameter and ring diameter must be coordinated with the material property of the elastic material chosen for the O-ring and accurately coordinated with the diameter and compressibility of the bait. Miscalculations of o-ring properties and sizing results in ineffective securement of hook 10 to individual baits 20 and/or severing of bait 20 through its cross-section. The O-ring is difficult to fit over the bait after a line has been attached to the eye of the hook. Often a fitting tool is required to stretch the o-ring to a larger size and pass it over the bait's oversized tail section and along the varying lengths of baits.

There is great value for an effective bait reinforcement and retaining system that is simply and easily applied and does not require devices or fixtures for application. Furthermore, it is advantageous for the angler to have flexibility for adjusting the amount of radial compression and securing of the bait to the jig and/or hook of baits with various sizes, styles, durometers and configurations.

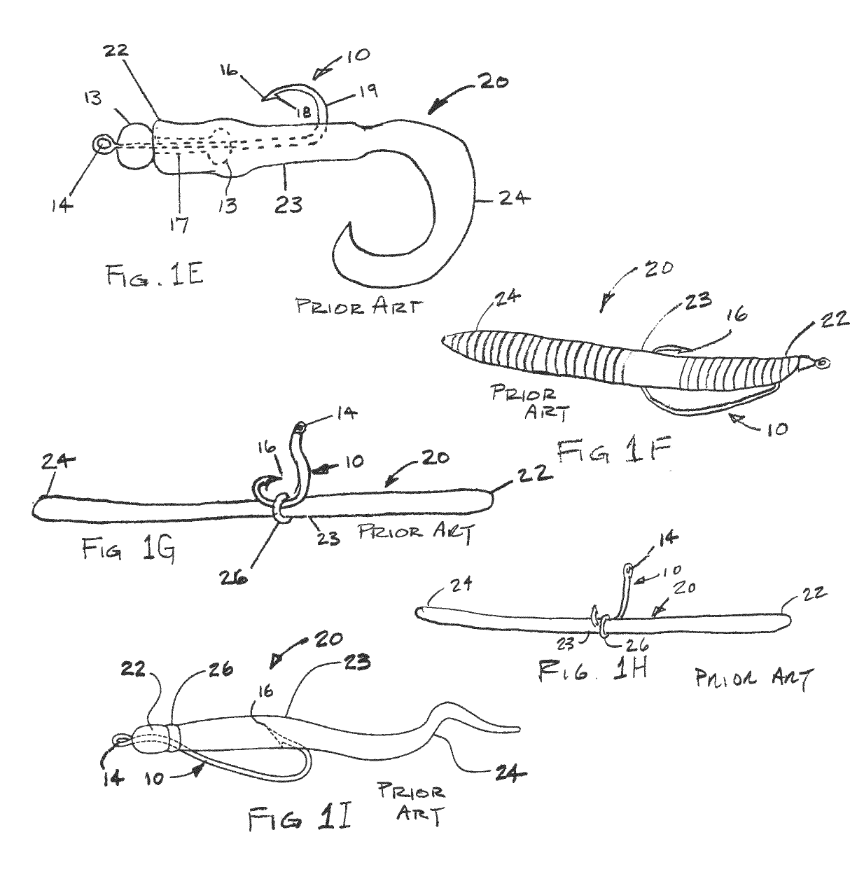

FIG. 2 shows a strip 30 of self-adhering flexible material as described herein for reinforcing a portion of a bait having a fishing hook inserted therethrough. Strip 30 has a length, a width, a thickness and two opposing ends, a first end 32 and a second end 34. The length is typically much greater than the width; the thickness is relatively thin, such as about 0.05 mm. Typical lengths may range from about 25 mm to about 100 mm, while widths may range from about 1.5 mm to about 13 mm. Typically, a desirable length will be sufficient to wrap tightly about the circumference of a bait in an amount to provide effective reinforcement, typically wrapping about 1.3 to 3 times around the bait circumference. These dimensions are not intended to be limiting and may be any dimension that functions in the general manner described herein.

Strip 30 in one embodiment is a strip of self-adhering elastomeric material such as a silicone tape. One such tape is “Stretch and Seal” Silicone Sealing Tape made by Nashua Tape Products (Berry Plastic Corporation, Franklin Ky. 42134, www.berryplastics.com). A strip of this material may be quickly and easily wrapped around a bait to reinforce angler determined portion/s of the bait adding radial compression to resist the undesirable hook displacement and pulling out of the hook from the bait during retrieval along with inhibiting tears and damage to the bait in the location which the hook is inserted. This reinforcement very effectively reduces the risk of the hook inadvertently being relocated and pulling free from the bait.

In another embodiment strip 30 may be a strip of flexible material that has an adhesive joined to one surface near end 34. The adhesive is oriented to the inner surface of the wrapping and causes the end 34 of strip 30 to adhere to the underlying circumferential wrap of strip 30.

In another embodiment strip 30 may be a strip of flexible material that has an adhesive jointed to one surface near the first end 32 to adhere to the bait for assisting in attachment of the reinforcing material.

In another embodiment the self-adhering flexible strip 30 may include Velcro. The Velcro may be provided in any relationship with the strip that results in the strip being self-adhering when circumferentially wrapped. The Velcro would typically be affixed to one side of strip 30 near end 34 and further include Velcro affixed to the opposite side of strip 30. Strip 30 is then wrapped circumferentially around a bait to reinforce the joining to hook 10 with Velcro on end 34 facing inward and the Velcro affixed to the opposite side facing outward, allowing the Velcro on end 34 to attach to underlying, outward facing Velcro. Typically, the Velcro would be arranged to have the hooks on one side of the strip and the loops on the opposite side of the strip.

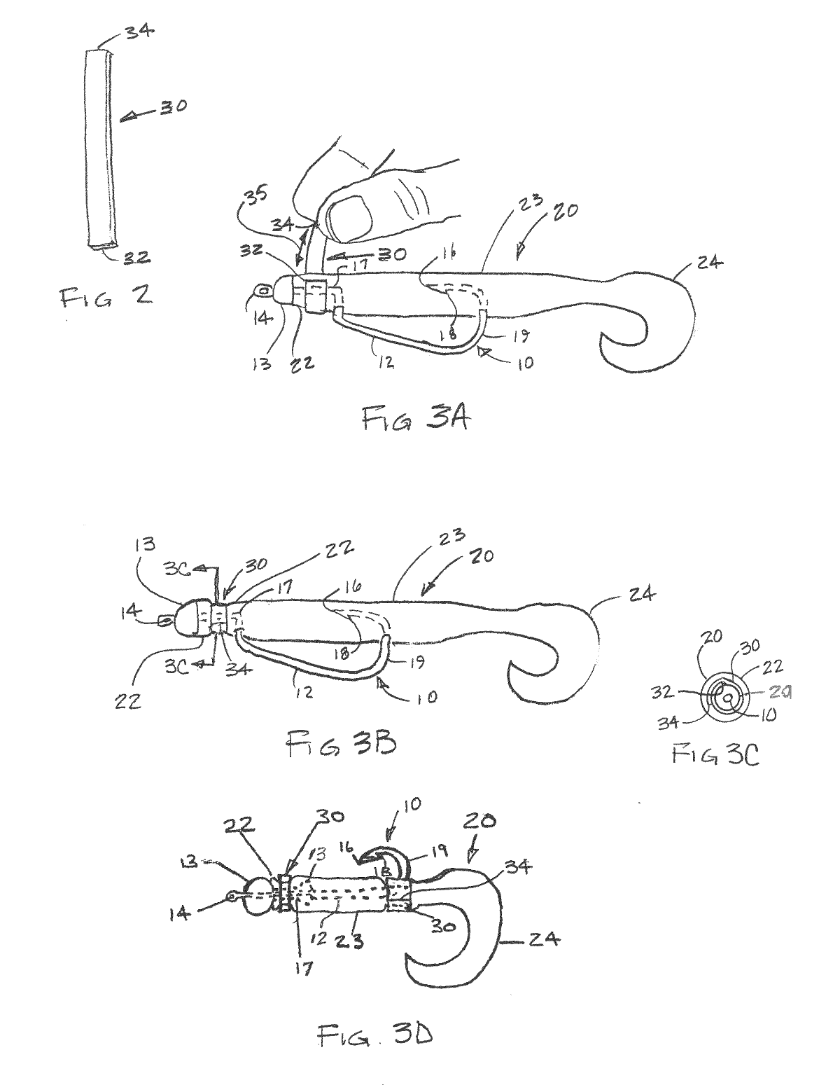

FIG. 3A shows the application of a strip 30 of self-adhering flexible material to a portion (the proximal region 22) of a bait 20 having the belly portion 17 of a fishing hook 10 inserted axially therethrough. The first end 32 is held against the outer surface of the outer surface of the proximal end 22 of bait 20 with the thumb and forefinger of one hand (not shown for clarity) while tension (arrows 35) is applied from the second end 34 of strip 30 by the thumb and forefinger of the other hand. After one full wrap with strip 30 of the circumference of the proximal end 22 of bait 20 is achieved (so that the first end 32 of strip 30 is covered by a portion of the length of strip 30, the wrapping may be continued with release of the thumb and forefinger of the first hand until the wrap has overlapped end 32 while maintaining tension on strip 30 with the thumb and forefinger of the second hand. More wrapping may be applied as necessary or desired after end 32 has been overlapped. Keeping tension on strip 30 during wrapping results in compression of the underlying soft bait 20 as generally shown by FIG. 3B. It is preferred that no tension is applied to the final 0.5 to 1.0 cm of the wrapping of the strip in order to enhance adhesion of this final portion of the strip. Strip 30 effectively adheres to itself during the overwrapping process, which is quickly and simply accomplished and results in very effective reinforcement of the portion of the bait 20 to hook 10. This application method provides the angler full control and adjustability to optimize radial compression to resist the undesirable hook displacement, bait damage and pulling out of the hook from the bait during retrieval along with positioning strip 30 in location/s inhibiting tears and damage to the bait in angler desired location/s.

FIG. 3B shows a portion of a bait having the shank 17 of a fishing hook 10 inserted axially therethrough, after the completed application by wrapping of a strip 30 of self-adhering flexible material to the relevant portion of the bait 20. FIG. 3C shows a transverse cross section of FIG. 3B taken at the location of the applied strip of self-adhering flexible material. It is seen how the wrapping of strip 30 may be applied with enough tension to result in radial compression of an underlying soft artificial bait 20. FIGS. 3B and 3C show that the wrapping constitutes at least a full circumference of the bait; it is appreciated that one and a half, two, three or even more wraps may be applied resulting in the opposing ends of the strip being effectively overlapped and thereby providing good adhesion in the overlapped portions of the strip material. It is also appreciated that two or more discrete strips may be applied on top of another, although typically a little more than one full circumference of wrapping of a single strip that gives some degree of overlap (perhaps 45 to 90 degrees of revolution) can be sufficient.

FIG. 3D shows a proximal region 22 of bait 20 with the shank 12 of hook 10 having a molded, weighted sinker 13 that has been inserted axially into that region of bait 20. This fishing lure is shown as it would appear after the completed application by wrapping of a strip 30 of self-adhering flexible material over the bait 20 in the location corresponding to the belly section 17 created in the molded, weighted sinker 13. Multiple (two or more) locations of wrap 30 for areas of bait reinforcement and resistance to hook displacement and bait damage may be desired such as in the middle region 23 of bait 20. It is apparent that the location of the application of strip 30 may be at any desired location on bait 20 that allows for effective reinforcement of the joining of hook 10 and bait 20.

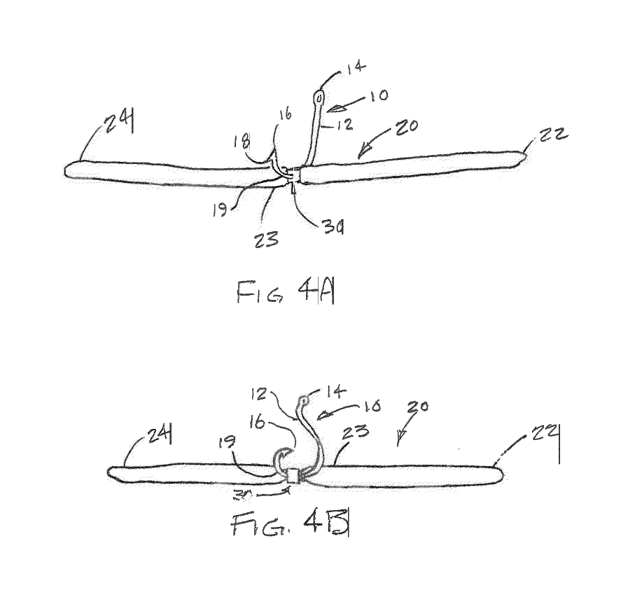

FIG. 4A shows a fishing hook 10 inserted through a portion of a bait 20, in this case the middle region 23 that has been reinforced with a strip 30 of self-adhering flexible material with the hook piercing the circumferential band formed by the wrapped strip. FIG. 4B shows a fishing hook 10 positioned against the outer surface of a portion of a bait 20 wherein a strip of self-adhering flexible material has been wrapped around bait 20 and hook 10 where they are in contact with each other, with the hook passing inside of the wrapped band formed by the strip. It is noteworthy that the location of the self-adhering flexible material can be along any length of the bait and the bait may be artificial, or may be a natural bait such as a worm, shad, crayfish, shrimp or crab.

One or more strips 30 may be conveniently packaged by arranging the strip or strips (previously manufactured to the selected dimensions) as desired on a protective sheet of release material such as a plastic sheet. A preferred material for a plastic release sheet is biaxially-oriented polyethylene terephthalate. The release material must be a material to which the strips will adhere sufficiently well to maintain their position on the sheet but will still effectively allow easy and immediate release of a selected strip when a user desires to use that strip. The sheet may be of any thickness desired in order to provide the desired amount of flexibility or stiffness. Additionally, a second release sheet is placed over the top of the strip or strips as a protective material. The upper and lower sheets of protective release material provide not only mechanical protection against physical damage but also prevent contamination of the strips 30 by dirt, etc. prior to use. A single sheet may be provided over several strips or alternatively individual strips of the release material may be provided over the upper surface of the individual strips. Preferably, the upper sheet of release material is thinner and more flexible than the lower sheet of release material. After being protected on both lower and upper surfaces by sheets of release material, the strip or strips may then be placed and sealed into suitable packaging material (e.g., relatively thin polyethylene packaging material). Suitable instructions for use are preferably provided.

In use, if an upper sheet of protective release material is provided, then that upper sheet may be easily peeled back to provide access to one or more strips, allowing a user to easily remove a strip from the lower sheet of release material and then replace the upper sheet of release material until it is desired to use still another strip.

Alternatively, if individual protective strips of release sheet material are provided on the upper surface of each individual strip, then a user would first remove an individual strip from the lower sheet of release material and then remove the strip of release material from the upper surface of the strip 30 prior to wrapping a bait with the strip.

If two or more strips are desired to be provided within a single package, the strips may be provided singly with a space between the adjacent strips, or alternatively two or more strips may be provided in a single sheet, having been manufactured as a single sheet with score lines or perforations defining adjacent strips within the same sheet of strips. In use, the individual strips may be easily torn away from adjacent strips, the score lines or perforation lines visually defining the individual strips for a user.

In addition to being directed to the embodiments described above and claimed below, the present invention is further directed to embodiments having different combinations of the features described above and claimed below. As such, the invention is also directed to other embodiments having any other possible combination of the dependent features claimed below.

Numerous characteristics and advantages of the present invention have been set forth in the preceding description, including preferred and alternate embodiments together with details of the structure and function of the invention. The disclosure is intended as illustrative only and as such is not intended to be exhaustive. It will be evident to those skilled in the art that various modifications may be made, especially in matters of structure, materials, elements, components, shape, size and arrangement of parts within the principals of the invention, to the full extent indicated by the broad, general meaning of the terms in which the appended claims are expressed. To the extent that these various modifications do not depart from the spirit and scope of the appended claims, they are intended to be encompassed therein.

We claim:

1. A fishing lure comprising a fishing hook joined to a portion of a bait wherein a strip of self-adhering flexible material having two opposing ends is wrapped around the portion of the bait.

2. A fishing lure according to claim 1 wherein the strip of self-adhering flexible material is an elastomeric material.

3. A fishing lure according to claim 2 wherein the elastomeric material is silicone.

4. A fishing lure according to claim 1 wherein the bait is an artificial bait.

5. A fishing lure according to claim 4 wherein the artificial bait comprises a soft, flexible material.

6. A fishing lure according to claim 5 wherein the soft, flexible material comprises plastisol.

7. A fishing lure according to claim 5 wherein the artificial bait is radially compressed by the strip.

8. A fishing lure according to claim 1 wherein the bait has a proximal region, a middle region and a distal region, and the portion of the bait lies in the proximal region.

9. A fishing lure according to claim 1 wherein the bait has a proximal region, a middle region and a distal region, and the portion of the bait lies in the middle region.

10. A fishing lure according to claim 1 wherein the bait has a proximal region, a middle region and a distal region, and the portion of the bait lies in the distal region.

11. A fishing lure according to claim 1 wherein the strip includes an attractant.

12. A fishing lure according to claim 1 wherein the strip includes a colorant.

13. A fishing lure according to claim 12 wherein the colorant is red.

14. A fishing lure according to claim 1 wherein the strip includes an adhesive at at least one end.

15. A fishing lure according to claim 1 wherein the strip includes Velcro™.

16. A fishing lure comprising a strip of self-adhering flexible material having two opposing ends, formed into a circumferential band wherein the opposing ends are overlapped and further having a fishing hook inserted through the circumferential band.

17. A fishing lure according to claim 16 wherein the hook pierces the band,

18. A fishing lure according to claim 16 wherein the hook passes through the inside of the band.

19. A fishing lure according to claim 16 wherein the band is located around a portion of a bait.

20. A fishing lure according to claim 19 wherein the bait comprises an artificial bait of soft flexible material.

21. A fishing lure according to claim 20 wherein the soft, flexible material comprises plastisol.

22. A fishing lure according to claim 16 wherein the strip of self-adhering flexible material includes Velcro™.

23. A fishing lure according to claim 16 wherein the strip of self-adhering flexible material includes an adhesive.

24. A fishing lure according to claim 16 wherein the strip of self-adhering flexible material comprises an elastomeric material.

25. A fishing lure according to claim 24 wherein the elastomeric material comprises silicone.

26. A method of reinforcing attachment of a fishing hook to a bait comprising:
a) providing a bait and a fishing hook;
b) inserting a hook through a portion of the bait; and
c) wrapping a strip of self-adhering flexible material having two opposing ends around the portion of the bait.

27. A method according to claim 26 wherein the bait is a natural bait.

28. A method according to claim 27 wherein the natural bait is a worm,

29. A method according to claim 27 wherein the natural bait is a shad.

30. A method according to claim 26 wherein the bait is an artificial bait.

31. A method according to claim 30 wherein artificial bait comprises a soft, flexible material.

32. A method according to claim 31 wherein the soft, flexible material is a plastisol.

33. A method according to claim 26 wherein the bait has a proximal region, a middle region and a distal region, and the portion of the bait lies in the proximal region.

34. A method according to claim 26 wherein the bait has a proximal region, a middle region and a distal region, and the portion of the bait lies in the middle region.

35. A method according to claim 26 wherein the bait has a proximal region, a middle region and a distal region, and the portion of the bait lies in the distal region.

36. A method according to claim 26 performed by a manufacturer.

37. A method according to claim 26 performed by an angler.

38. A method according to claim 26 wherein the strip of self-adhering flexible material includes Velcro™.

39. A method according to claim 26 wherein the strip of self-adhering flexible material includes an adhesive.

40. A method according to claim 26 wherein the strip of self-adhering flexible material comprises an elastomeric material.

41. A method according to claim 40 wherein the elastomeric material comprises silicone.
